(19) United States
(12) Patent Application Publication
(10) Pub. No.: US 2010/0132021 A1
(43) Pub. Date: May 27, 2010

(54) INTEGRATION AUTHENTICATION METHOD AND INTEGRATION AUTHENTICATION SERVER

(76) Inventor: Seong Ju Kim, Seoul (KR)

Correspondence Address: THE NATH LAW GROUP, 112 South West Street, Alexandria, VA, 22314, US

(21) Appl. No.: 12/451,222

(22) PCT Filed: May 2, 2008
(86) PCT No.: PCT/KR2008/002489

§ 371 Date: Nov. 2, 2009

(30) Foreign Application Priority Data
May 3, 2007 (KR) 10-2007-0042914

(51) Int. Cl. H04L 9/32; G06F 7/04

(52) U.S. Cl. 726/7

(57) ABSTRACT

Provided are an integrated authentication method and an integrated authentication server. The integrated authentication method using the integrated authentication server includes receiving integrated authentication request information and a company code for password authentication by the integrated authentication server, requesting a serial number of a predetermined authentication device and determining whether the received company code is identical to a provider company code in response to the received serial number, if the received company code is identical to the provider company code, requesting generation of a test password and determining whether a received test password is identical to a reference password, and if the test password is identical to the reference password, approving password authentication using the authentication device at a provider company corresponding to the provider company code. The integrated authentication method and the integrated authentication server enable all types of financial trades and e-commerce using a single authentication device authenticated by the integrated authentication server and allow the authentication device to avoid the risk of hacking. Moreover, companies commonly bear an authentication fee for the authentication device, thereby promoting the spread and utilization of the authentication device.

### TECHNICAL FIELD

The present invention generally relates to an integrated authentication method using an integrated authentication server and the integrated authentication server, and more particularly, to an integrated authentication method and an integrated authentication server, whereby a user can conduct business with a company only through a simple to authentication procedure by using a portable password generator which has been authenticated by another company such as an online game company or a portal site.

### BACKGROUND ART

With increase in the number of fields, such as electronic commerce (“e-commerce”) using the Internet and Internet banking, which demand user authentication systems, security for the user authentication systems has emerged as an important issue.

Although security trades for e-commerce and banking have been made by using a certification code, the certification code proves to be not safe and even to be prone to hacking.

To solve a problem such as hacking, an instant password generator such as a one time password (OTP) token is used. However, since an OTP allocated for Internet banking cannot be commonly used between different banks, a separate device such as an OTP token has to be provided by an individual bank, which is very unreasonable. Accordingly, there is a need for a system for authenticating authentication devices in an integrated manner.

### DISCLOSURE

Technical Problem

The present invention provides an integrated authentication method for authenticating an authentication device in an integrated manner in order to make the authentication device available at any site.

The present invention also provides an integrated authentication server for authenticating an authentication device in an integrated manner in order to make the authentication device available at any site.

Technical Solution

According to an aspect of the present invention, there is provided an integrated authentication method using an integrated authentication server. The integrated authentication method includes receiving integrated authentication request information and a company code for password authentication by the integrated authentication server, requesting a serial number of a predetermined authentication device and determining whether the received company code is identical to a provider company code in response to the received serial number, if the received company code is identical to the provider company code, requesting generation of a test password and determining whether a received test password is identical to a reference password, and if the test password is identical to the reference password, approving password authentication using the authentication device at a provider company corresponding to the provider company code.

The integrated authentication server may include a database which stores the provider company code of the provider company and the serial number of the authentication device provided by the provider company, and the determining of whether the company code is identical to the provider company code may include comparing the company code corresponding to the serial number of the authentication device with the stored provider company code to determine whether the company code is identical to the stored provider company code.

The integrated authentication method may further include, if the test password is identical to the reference password, registering the company code as the provider company code and registering the provider company code with a registration information sheet corresponding to the serial number of the authentication device.

The integrated authentication method may further include, if the received company code is not identical to the provider company code, requesting generation of the test password and determining whether the received test password is identical to the reference password, if the test password is identical to the reference password, registering the company code as a member company code and registering the member company code with the registration information sheet corresponding to the serial number of the authentication device, approving password authentication using the authentication device at a member company corresponding to the member company code, and receiving authentication fee information of the member company and forwarding the authentication fee information to a corresponding provider company.

The provider company may be a company which initially provides the authentication device to a user, and the member company may be a company exclusive of the provider company, which desires password authentication using the authentication device provided by the provider company.

Each of the provider company and the member company may include an authentication server which performs user authentication by means of an identification (ID) of the user and password authentication using the authentication device. The integrated authentication server may generate the reference password if the authentication device corresponding to the serial number generates the test password. The authentication device may be a one time password (OTP) generator. The authentication device may be a password generator using fingerprint recognition or iris recognition, and the integrated authentication server may further fingerprint information or iris information of the user of the authentication device.

According to another aspect of the present invention, there is provided an integrated authentication server including a reception unit, a database, a first comparison unit, a second comparison unit, a verification unit, and a data generation unit.

The reception unit requests a serial number of an authentication device of a user in response to predetermined integrated authentication request information and a company code and receives the serial number. The database stores a provider company code of a provider company and a serial number of an authentication device provided by the provider company.

The first comparison unit compares the received company code and the received serial number with the provider company code and the serial number stored in the database. The second comparison unit requests generation of a test password of the authentication device of the user and determines whether the received test password is identical to a reference password.

The verification unit generates an authentication signal for permitting or rejecting use of the authentication device at a company corresponding to the company code in response to signals being output from the first comparison unit and the second comparison unit and generates a control signal for controlling registration of the serial number of the authentication device and the company code.

The data generation unit registers the serial number of the authentication device, and the company code as a provider company code or a member company code in response to the control signal and generates registration information sheets including the serial number of the authentication device and the provider company code and the member company code corresponding to the serial number.

The first comparison unit may output a first signal having a first logic level if the received company code and the received serial number are identical to the provider company code and the serial number stored in the database, and may output the first signal having a second logic level if the received company code and the received serial number are not identical to the provider company code and the serial number stored in the database, and the second comparison unit may output a second signal having the first logic level if the test password is identical to the reference password, and may output the second signal having the second logic level if the test password is not identical to the reference password.

The verification unit may generate the authentication signal for permitting use of the authentication device if the second signal being output from the second comparison unit has the first logic level, and may generate the authentication signal for rejecting use of the authentication device if the second signal being output from the second comparison unit has the second logic level.

The verification unit may output the control signal having the first logic level if the second signal being output from the second comparison unit has the first logic level and the first signal being output from the first comparison unit has the first logic level, and may output the control signal having the second logic level if the second signal being output from the second comparison unit has the first logic level and the first signal being output from the first comparison unit has the second logic level.

The data generation unit may register the company code as the provider company code if the control signal has the first logic level and may register the provider company code with a registration information sheet corresponding to the serial number of the authentication device, and the data generation unit may register the company code as the member company code if the control signal has the second logic level, and may register the member company code with the registration information sheet corresponding to the serial number of the authentication device.

The integrated authentication server may further include a fee control unit storing authentication fee information of a member company corresponding to the member company code and forwarding the authentication fee information to the provider company on the registration information sheet, if the control signal has the second logic level.

Each of the provider company and the member company may include an authentication server which performs user authentication by means of an identification (ID) of the user and password authentication using the authentication device. The integrated authentication server may further include a reference password generation unit generating the reference password if receiving the test password.

According to further another aspect of the present invention, there is provided an integrated authentication method using an integrated authentication server. The integrated authentication method includes receiving an access request for requesting an access using an authentication device from a user having the authentication device, requesting authentication for the authentication device by transmitting integrated authentication request information and a company code, and a serial number of the authentication device to the integrated authentication server in response to the access request, permitting the user's access using the authentication device if authentication for the authentication device is approved, and transmitting authentication fee information for the authentication device to the integrated authentication server.

The user may be provided with the authentication device from a predetermined provider company, and the integrated authentication method may further include forwarding the authentication fee information transmitted to the integrated authentication server to the provider company.

Advantageous Effects

As described above, the integrated authentication method and the integrated authentication server according to the present invention enable all types of financial trades and e-commerce using a single authentication device authenticated by the integrated authentication server and allow the authentication device to avoid the risk of hacking. Moreover, companies commonly bear an authentication fee for the authentication device, thereby promoting the spread and utilization of the authentication device.

### DESCRIPTION OF DRAWINGS

FIG. 1 is a flowchart illustrating an integrated authentication method using an integrated authentication server according to an embodiment of the present invention;

FIG. 2 is a flowchart for explaining a case where a company code is not identical to a provider company code in the flowchart illustrated in FIG. 1;

FIG. 3 is a view for explaining the integrated authentication method using the integrated authentication server, illustrated in FIG. 1; and

FIG. 4 is a block diagram illustrating the structure of the integrated authentication server illustrated in FIG. 3.

### BEST MODE

Hereinafter, embodiments of the present invention will be described in detail with reference to the accompanying drawings. It should be noted that like reference numerals refer to like elements illustrated in one or more of the drawings.

In the present invention, one (“a provider company”) of a plurality of companies such as game companies provides an authentication device to a user and the user registers a serial number of the authentication device and a provider company code and a providing fee of the provider company with an integrated authentication server.

The integrated authentication server generates a data field corresponding to the serial number and stores the provider company code in the data field. When the user accesses the integrated authentication server to use the authentication device in another company (“a member company”), the member company transmits user's authentication request information and a member company code to the integrated authentication server.

The integrated authentication server determines whether to approve authentication for the authentication device in response to the authentication request information and the member company code. If authentication is approved, the integrated authentication server receives authentication fee information of the member company from the member company and transmits the same to the provider company.

In this way, by using a single integrated authentication server, a plurality of companies can handle an authentication procedure with a single authentication device. The authentication device may be a one time password (OTP) generator and randomly generate a separate password at every access to a site for authentication, thereby avoiding the risk of hacking. Moreover, all types of financial trades and e-commerce operations can be conducted by using a single OTP generator, thereby providing convenience.

Since a company (“a provider company”) which initially provides an OTP generator to a user can receive a predetermined fee from another site or company (“a member company”) which performs an authentication procedure by using the OTP generator, the provider company can provide the OTP generator to the user at very low prices and thus the rapid spread of the OTP generator can also be made.

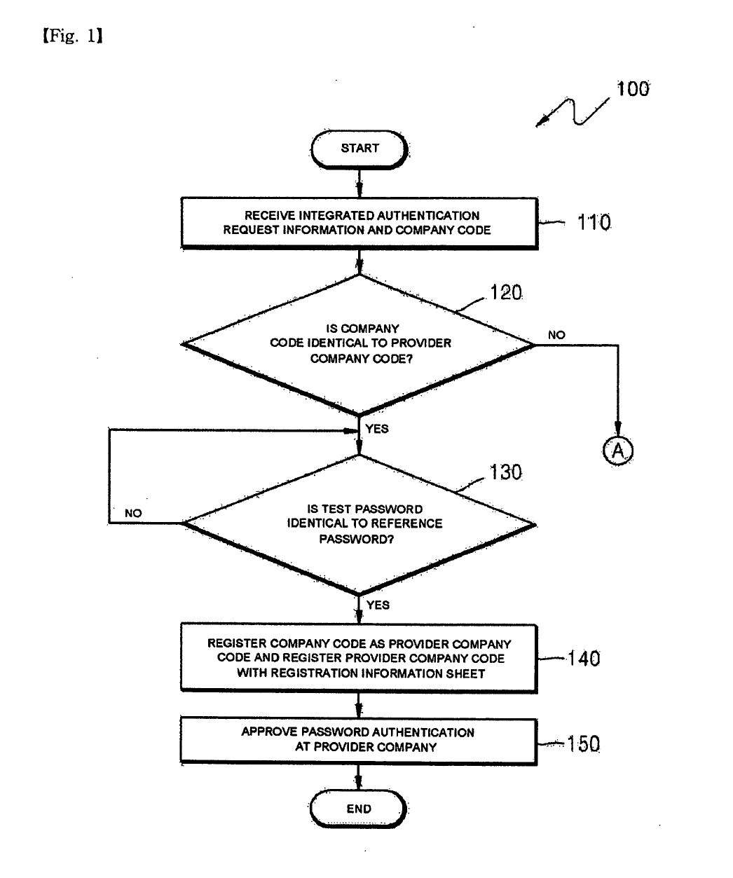

Hereinafter, an integrated authentication method and an integrated authentication server according to an embodiment of the present invention will be described with reference to FIGS. 1 through 4.

FIG. 1 is a flowchart illustrating an integrated authentication method using an integrated authentication server according to an embodiment of the present invention.

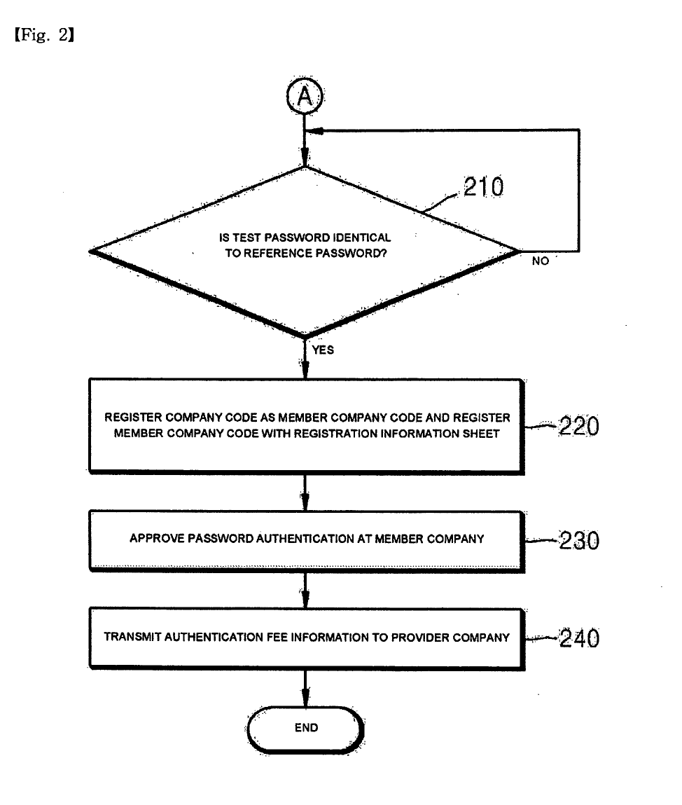

FIG. 2 is a flowchart for explaining a case where a company code is not identical to a provider company code in the flowchart illustrated in FIG. 1.

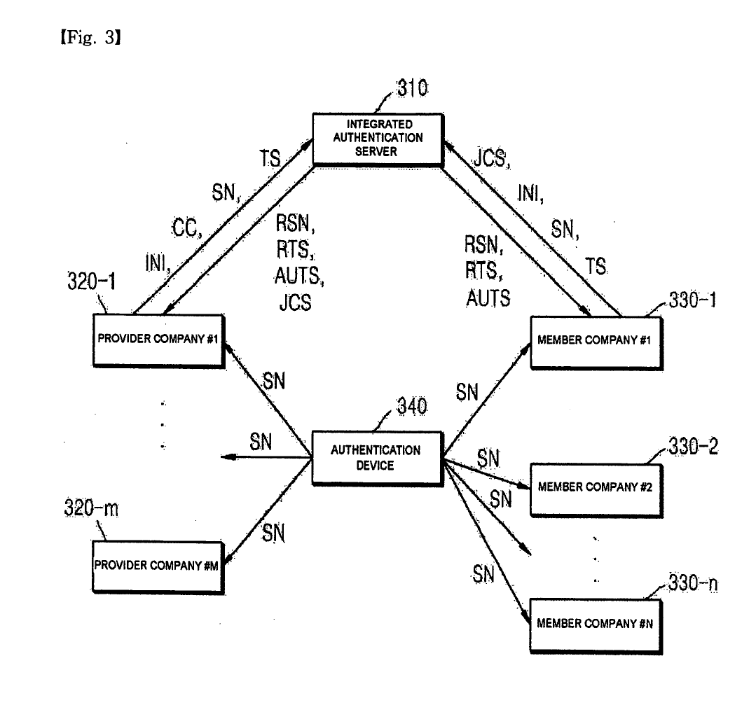

FIG. 3 is a view for explaining the integrated authentication method using the integrated authentication server, illustrated in FIG. 1.

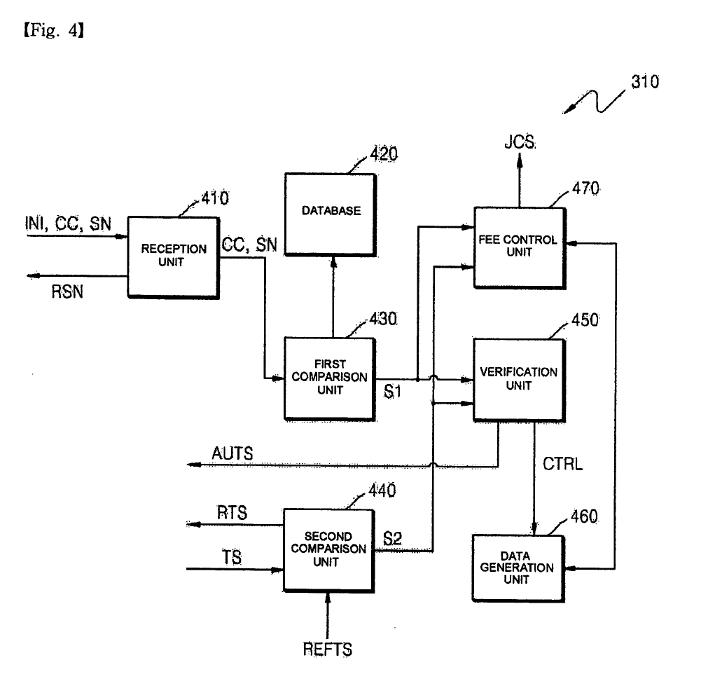

FIG. 4 is a block diagram illustrating the structure of the integrated authentication server illustrated in FIG. 3.

Referring to FIG. 3, an integrated authentication method using an integrated authentication server 310 according to an embodiment of the present invention includes a plurality of companies and the integrated authentication server 310. Herein, companies may be game companies, portable site providers, banks, securities companies, e-commerce companies, or any site that can provide contents to a user who is authenticated by an authentication device.

In the present invention, companies can be classified into provider companies (#1 to #M) 320-1 to 320-m and member companies (#1 to #N) 330-1 to 330-n. The provider companies 320-1 to 320-m initially provide an authentication device 340 to a user, and the member companies 330-1 to 330-n are the remaining companies, exclusive of the provider companies 320-1 to 320-m, which desire password authentication by using the authentication device 340 provided by the provider companies 320-1 to 320-Pm.

The provider companies 320-1 to 320-m and the member companies 330-1 to 330-n include authentication servers which perform user authentication by means of a user's identification (ID) and password authentication using the authentication device 340, respectively. In other words, the integrated authentication server 310 certify whether the authentication device 340 of the user has been legitimately issued and is now valid in order to allow a plurality of companies to use the authentication device 340. In order to use contents of the member companies 330-1 to 330-n, the user has to undergo a separate authentication procedure using an ID and a password at the separate authentication server included in each of the member companies 330-1 to 330-n by using the authentication device 340.

Hereinafter, an embodiment of the present invention will be described by using one of the plurality of member companies 330-1 to 330-n, i.e., the member company 330-1, and one of the plurality of provider companies 320-1 to 320-m, i.e., the provider company 320-1, for convenience of explanation.

Preferably, the authentication device 340 is an OTP generator. The authentication device 340 may also be a password generator using fingerprint recognition or iris recognition. In the following description, the authentication device 340 is assumed to be an OTP generator for convenience of explanation. However, it can be easily understood by those of ordinary skill in the art that the authentication device 340 is not limited to an OTP generator.

Referring to FIG. 1, an integrated authentication method 100 using an integrated authentication server according to an embodiment of the present invention includes receiving integrated authentication request information and a company code for password authentication by means of the integrated authentication server in operation 110.

A serial number of a predetermined authentication device is requested and it is determined whether the received company code is identical to a provider company code in response to the received serial number in operation 120.

Integrated authentication request information INI, a company code CC, a serial number request RSN, and a serial number SN are received by a reception unit 410 illustrated in FIG. 4. In other words, the reception unit 410 sends the serial number request RSN for requesting a serial number of the user's authentication device 340 in response to the integrated authentication request information INI and the company code CC and receives the serial number SN.

When the user having the authentication device 340 desires to use contents of the member company 330-1 or contents of the provider company 320-1 by using the authentication device 340, the reception unit 410 of the integrated authentication server 310 receives the integrated authentication request information INI and the company code CC from the member company 330-1 or the provider company 320-1.

The reception unit 410 of the integrated authentication server 310 sends the serial number request RSN for requesting the serial number of the authentication device 340 to a company having transmitted the company code CC and the integrated authentication request information INI in order to receive the serial number SN.

The integrated authentication server 310 determines whether the received company code CC is identical to the provider company code in operation 120. The integrated authentication server 310 includes a database 420 for storing the provider company code of the provider company 320-1 and the serial number SN of the authentication device 340 provided by the provider company 320-1.

In operation 120, the integrated authentication server 310 compares the company code CC corresponding to the serial number SN of the authentication device 340 with the stored provider company code in order to determine whether the received company code CC is identical to the provider company code.

The integrated authentication server 310 stores the serial number SN of the authentication device 340 provided by the provider company 320-1, together with the company code of the provider company 320-1, i.e., the provider company code, in the database 420. For example, if a company having a company code A sells 1000 authentication devices having serial numbers of 0001-1000 to users, the database 420 stores the serial numbers of the 1000 authentication devices, together with the company code A of the company as a provider company code.

Thus, if the received company code CC and the received serial number SN of the authentication device 340 are identical to the provider company code and a corresponding serial number stored in the database 420, the integrated authentication server 310 verifies that the authentication device 340 corresponding to the serial number SN currently received together with the company code CC is a valid authentication device provided by a company having the received company code CC to the user. In addition, the integrated authentication server 310 verifies that a company having transmitted the integrated authentication request information INI is not a member company, but is a provider company.

Such a verification operation is performed by a first comparison unit 430 of the integrated authentication server 310. In other words, the first comparison unit 430 compares the received company code CC and serial number SN with the provider company code and serial number stored in the database 420.

If the received company code CC and serial number SN are identical to the provider company code and serial number stored in the database 420, the integrated authentication server 310 requests generation of a test password, and determines whether the received test password is identical to a reference password in operation 130.

To re-verify that the authentication device 340 owned by the user is a valid authentication device, the integrated authentication server 310 sends a test password request RTS for requesting generation of the test password to the provider company 320-1 and receives a test password TS from the provider company 320-1. To this end, the integrated authentication server 310 further includes a reference password generation unit (not shown) for generating a reference password REFTS.

Operation 130 is performed by a second comparison unit 440 of the integrated authentication server 310. In other words, the second comparison unit 440 sends the test password request RTS for requesting generation of the test password TS for the authentication device 340 of the user and determines whether the received test password TS is identical to the reference password REFTS.

If the received test password TS is identical to the reference password REFTS, the integrated authentication server 310 registers the company code CC as the provider company code and registers the provider company code with a registration information sheet corresponding to the serial number SN of the authentication device 340 in operation 140.

Operation 140 is performed by a data generation unit 460 of the integrated authentication server 310. The data generation unit 460 registers the serial number SN of the authentication device 340, and the received company code CC as the provider company code in response to a control signal CTRL, and generates registration information sheets (not shown) having the serial number SN of the authentication device 340 and provider company code information corresponding to the serial number SN.

Since the authentication device 340 used by the user can be used at the provider company or the plurality of member companies in authentication for use of contents of the provider company or the plurality of member companies, the integrated authentication server 310 generates the registration information sheets to store and manage information regarding at which member company or provider company the authentication device 340 is being used.

After storing various information in the registration information sheets, the integrated authentication server 310 approves password authentication at a provider company corresponding to the provider company code using the authentication device 340 in operation 150. If the test password TS is identical to the reference password REFTS, it means that the authentication device 340 of the user is valid. Thus, the integrated authentication server 310 sends an authentication signal AUTS for permitting use of the authentication device 340 for authentication at the provider company 320-1 to the provider company 320-1 having transmitted the integrated authentication request information INI.

Operation 150 is performed by a verification unit 450 of the integrated authentication server 310. In other words, the verification unit 450 generates the authentication signal AUTS for permitting or rejecting use of the authentication device 340 at a company corresponding to the company code CC in response to signals being output from the first comparison unit 430 and the second comparison unit 440, and generates the control signal CTRL for controlling registration of the serial number SN of the authentication device 340 and the company code CC.

Operations 120 through 150 will be described in more detail.

If the received company code CC and serial number SN are identical to the provider company code and serial number stored in the database 420, the first comparison unit 430 outputs a signal S1 having a first logic level. Otherwise, the first comparison unit 430 outputs the signal Si having a second logic level. For convenience of explanation, it is assumed that the first logic level is a high level and the second logic level is a low level. However, the present invention is not limited to such an assumption.

If the test password TS is identical to the reference password REFTS, the second comparison unit 440 outputs a signal S2 having the first logic level. Otherwise, the second comparison unit 440 outputs the signal S2 having the second logic level.

If the signal S2 output from the second comparison unit 440 has the first logic level, i.e., the test password TS is identical to the reference password REFTS, the verification unit 450 generates the authentication signal AUTS for permitting use of the authentication device 340 and outputs the authentication signal AUTS to the provider company 320-1. If the signal S2 output from the second comparison unit 440 has the second logic level, i.e., the test password TS is not identical to the reference password REFTS, the verification unit 450 generates the authentication signal AUTS for rejecting use of the authentication device 340.

If the signal S2 output from the second comparison unit 440 has the first logic level and the signal S1 output from the first comparison unit 430 has the first logic level, i.e., the test password TS is identical to the reference password REFTS and the received company code CC and serial number SN are identical to the provider company code and the serial number stored in the database 420, the verification unit 450 generates the control signal CTRL having the first logic level and outputs the control signal CTRL to the data generation unit 460.

The data generation unit 460 then registers the received company code CC as the provider company code in response to the control signal CTRL having the first logic level and registers the provider company code with a registration information sheet corresponding to the serial number SN of the authentication device 340.

The above is a description regarding operations of the integrated authentication server 310 in the case that the user uses the authentication device 340 at a provider company. Hereinafter, a description will be made of operations of the integrated authentication server 310 in the case that the user uses the authentication device 340 at a member company.

Referring to FIG. 2, if a company code is not identical to a provider company code in operation 120 of FIG. 1, generation of a test password is requested, and it is determined whether the received test password is identical to a reference password in operation 210.

If the received company code CC is not identical to the provider company code stored in the database 420 in operation 120 of FIG. 1, it means that a company having transmitted the company code CC to the integrated authentication server 310 is not a provider company. In this case, the integrated authentication server 310 sends the test password request RTS to the company and determines whether the received test password TS is identical to the reference password REFTS.

If the test password TS is identical to the reference password REFTS, the integrated authentication server 310 registers the company code as a member company code and registers the member company code with a registration information sheet corresponding to the serial number SN of the authentication device 340 in operation 220.

If the received company code CC is not identical to the provider company code stored in the database 420 and the test password T S is not identical to the reference password REFTS, it means that a company whose contents the user desires to consume by using the authentication device 340 is not a provider company, but is a member company. Thus, the integrated authentication server 310 registers the received company code CC as a member company code and registers the member company code with a registration information sheet (not shown) corresponding to the serial number SN of the authentication device 340.

Through such a procedure, a provider company code corresponding to a serial number SN of each authentication device 340 and a plurality of member company codes are registered with registration information sheets included in the integrated authentication server 310, and the member company codes and the provider company codes registered with the registration information sheets represent companies at which the authentication device 340 corresponding to each of the companies can be used.

The integrated authentication server 310 approves password authentication using the authentication device 340 at the member company corresponding to the member company code in operation 230. The integrated authentication server 310 notifies the member company 330-1 that the authentication device 340 is a valid authentication device available at the member company 330-1 in order to allow the user to access a site related to the member company 330-1 by using the authentication device 340.

Operations 210 through 240 will be described in more detail with reference to FIG. 4.

If the received company code CC and serial number SN are not identical to the provider company code and serial number stored in the database 420, the first comparison unit 430 outputs the signal S1 having the second logic level. If the test password TS is identical to the reference password REFTS, the second comparison unit 440 outputs the signal S2 having the first logic level. Otherwise, the second comparison unit 440 outputs the signal S2 having the second logic level.

If the signal S2 output from the second comparison unit 440 has the first logic level, i.e., the test password TS is identical to the reference password REFTS, the verification unit 450 generates the authentication signal AUTS for permitting use of the authentication device 340 and outputs the authentication signal AUTS to the member company 330-1. If the signal S2 output from the second comparison unit 440 has the second logic level, i.e., the test password TS is not identical to the reference password REFTS, the verification unit 450 generates the authentication signal AUTS for rejecting use of the authentication device 340 and outputs the authentication signal AUTS to the member company 330-1.

If the signal S2 output from the second comparison unit 440 has the first logic level and the signal S1 output from the first comparison unit 430 has the second logic level, i.e., the test password TS is identical to the reference password REFTS and the received company code CC and serial number SN are not identical to the provider company code and serial number stored in the database 420; the verification unit 450 generates the control signal CTRL having the second logic level and outputs the control signal CTRL to the data generation unit 460.

The data generation unit 460 then registers the received company code CC as a member company code in response to the control signal CTRL having the second logic level, and registers the member company code with a registration information sheet corresponding to the serial number SN of the authentication device 340.

In this way, the integrated authentication server 310 determines at which company the authentication device 340 is to be used, classifies a corresponding company as a provider company or a member company, and stores information about a provider company and a plurality of member companies at which the authentication device 340 is available.

As mentioned previously, the authentication device 340 may be an OTP generator. Thus, a member company and a provider company both have to include authentication servers capable of generating a password for OTP operations.

The authentication device 340 may also be a password generator using fingerprint recognition or iris recognition. In this case, the integrated authentication server 310 has to further perform an operation of receiving user's fingerprint or iris information from the authentication device 340 and storing the received information, and has to further include a storage device for the operation.

The integrated authentication method 100 according to an embodiment of the present invention includes operation 240 of receiving authentication fee information of a member company and transmitting the authentication fee information to a corresponding provider company.

Operation 240 is performed by a fee control unit 470 of the integrated authentication server 310. If the control signal CTRL has the second logic level, i.e., a company having transmitted the integrated authentication request information INI and the company code CC to the integrated authentication server 310 is a member company, the fee control unit 470 stores authentication fee information JCS of a member company corresponding to a member company code and transmits the authentication fee information JCS to the provider company 320-1 on a registration information sheet.

The provider company 320-1 may provide the authentication device 340 to the user free or at a low price for the wide spread of the authentication device 340. In this case, to alleviate the expense burden of purchasing the authentication device 340 from the provider company 320-1, the member company 330-1 at which the authentication device 340 is used may pay a predetermined authentication fee to the provider company 320-1.

The integrated authentication server 310 receives and stores the authentication fee information JCS provided by the member company 330-1 and transmits the authentication fee information JCS to the provider company 320-1 which provides the authentication device 340, thereby alleviating the expense burden of purchasing the authentication device 340 from the provider company 320-1 and promoting the spread of the authentication device 340.

An integrated authentication method using an integrated authentication server according to another embodiment of the present invention includes an operation of receiving an access request for requesting an access using an authentication device from a user having the authentication device, an operation of requesting authentication for the authentication device by transmitting integrated authentication request information and a company code, and a serial number of the authentication device to the integrated authentication server in response to the access request, an operation of permitting the user's access using the authentication device if authentication for the authentication device is approved, and an operation of transmitting authentication fee information for the authentication device to the integrated authentication server.

The integrated authentication method according to another embodiment of the present invention will be described from a point of view of the member company 330-1 of FIG. 3.

In other words, the member company 330-1 receives an access request for requesting an access using the authentication device 340 from a user having the authentication device 340. The user has been provided with the authentication device 340 from the provider company 320-1.

The member company 330-1 requests authentication for the authentication device 340 by transmitting integrated authentication request information and a company code, and a serial number of the authentication device 340 to the integrated authentication server 310 in response to the access request. The member company 330-1 transmits its company code and the serial number of the authentication device 340 together with the integrated authentication request information in order to request authentication for the authentication device 340. The integrated authentication server 310 registers the serial number of the authentication device 340 and the company code with a registration information sheet and compares a test password generated by the authentication device 340 with a reference password for authentication of the authentication device 340. The integrated authentication server 310 includes a registration information sheet corresponding to each authentication device and registers information about a member company at which the authentication device is used and information about a provider company which provides the authentication device with a corresponding registration information sheet.

The registration information sheets are required to analyze a plurality of member companies at which authentication devices are used, to receive authentication fee information from each of the member companies, and to provide the authentication fee information to a provider company.

Once authentication for the authentication device is approved, the member company 330-1 permits the user's access using the authentication device 340. The member company 330-1 includes an authentication server for permitting an access by means of a user's ID and a password generated by the authentication device 340.

The member company 330-1 transmits authentication fee information for the authentication device 340 to the integrated authentication server 310. The authentication fee information is then forwarded to the provider company 320-1. In other words, since the user accesses a site of the member company 330-1 by using the authentication device 340 provided by the provider company 320-1, the member company 330-1 pays an authentication fee for the authentication device 340 to the provider company 320-1 to the effect that the member company 330-1 partially bears a providing fee of the provider company 320-1 incurred in providing the authentication device 340. The integrated authentication server receives the authentication fee information and provides the same to the provider company 320-1 in order to let the provider company 320-1 know an authentication fee to be paid by the member company 330-1.

Since the user may access a plurality of member companies by using the authentication device, the provider company may receive authentication fees from the plurality of member companies via the integrated authentication server. Therefore, the provider company can more actively provide the authentication device to the user and the utilization of the authentication device can also be promoted in that course.

The authentication device may be an OTP generator. Thus, the integrated authentication method and the integrated authentication server according to the present invention can accelerate the utilization and spread of the OTP generator and allow users to safely conduct e-commerce against hacking.

Operations of the integrated authentication method and the structure of the integrated authentication server according to another embodiment of the present invention have already been described with reference to FIGS. 1 through 4, and thus will not be described in detail. While the present invention has been particularly shown and described with reference to embodiments thereof, it will be understood by one of ordinary skill in the art that various changes in form and detail may be made therein without departing from the spirit and scope of the present invention as defined by the following claims.

### INDUSTRIAL APPLICABILITY

The present invention can be used in the field of e-commerce using the Internet.

1. An integrated authentication method using an integrated authentication server, the integrated authentication method comprising:
receiving integrated authentication request information and a company code for password authentication by the integrated authentication server;
requesting a serial number of a predetermined authentication device and determining whether the received company code is identical to a provider company code in response to the received serial number;
if the received company code is identical to the provider company code, requesting generation of a test password and determining whether a received test password is identical to a reference password; and
if the test password is identical to the reference password, approving password authentication using the authentication device at a provider company corresponding to the provider company code.

2. The integrated authentication method of claim 1, wherein the integrated authentication server comprises a database which stores the provider company code of the provider company and the serial number of the authentication device provided by the provider company, and
the determining of whether the company code is identical to the provider company code comprises comparing the company code corresponding to the serial number of the authentication device with the stored provider company code to determine whether the company code is identical to the stored provider company code.

3. The integrated authentication method of claim 2, further comprising:
if the test password is identical to the reference password, registering the company code as the provider company code and registering the provider company code with a registration information sheet corresponding to the serial number of the authentication device.

4. The integrated authentication method of claim 3, further comprising:
if the received company code is not identical to the provider company code, requesting generation of the test password and determining whether the received test password is identical to the reference password;
if the test password is identical to the reference password, registering the company code as a member company code and registering the member company code with the registration information sheet corresponding to the serial number of the authentication device!
approving password authentication using the authentication device at a member company corresponding to the member company code! and
receiving authentication fee information of the member company and forwarding the authentication fee information to a corresponding provider company.

5. The integrated authentication method of claim 4, wherein the provider company is a company which initially provides the authentication device to a user, and the member company is a company exclusive of the provider company, which desires password authentication using the authentication device provided by the provider company.

6. The integrated authentication method of claim 5, wherein each of the provider company and the member company comprises an authentication server which performs user authentication by means of an identification (ID) of the user and password authentication using the authentication device.

7. The integrated authentication method of claim 1, wherein the integrated authentication server generates the reference password if the authentication device corresponding to the serial number generates the test password.

8. The integrated authentication method of claim 1, wherein the authentication device is a one time password (OTP) generator.

9. The integrated authentication method of claim 1, wherein the authentication device is a password generator using fingerprint recognition or iris recognition, and the integrated authentication server further comprises fingerprint information or iris information of the user of the authentication device.

10. An integrated authentication server comprising:
a reception unit requesting a serial number of an authentication device of a user in response to predetermined integrated authentication request information and a company code and receiving the serial number;
a database storing a provider company code of a provider company and a serial number of an authentication device provided by the provider company;
a first comparison unit comparing the received company code and the received serial number with the provider company code and the serial number stored in the database;
a second comparison unit requesting generation of a test password of the authentication device of the user and determining whether the received test password is identical to a reference password;
a verification unit generating an authentication signal for permitting or rejecting use of the authentication device at a company corresponding to the company code in response to signals being output from the first comparison unit and the second comparison unit and generating a control signal for controlling registration of the serial number of the authentication device and the company code; and
a data generation unit registering the serial number of the authentication device, and the company code as a provider company code or a member company code in response to the control signal and generating registration information sheets including the serial number of the authentication device and the provider company code and the member company code corresponding to the serial number.

11. The integrated authentication server of claim 10, wherein the first comparison unit outputs a first signal having a first logic level if the received company code and the received serial number are identical to the provider company code and the serial number stored in the database, and outputs the first signal having a second logic level if the received company code and the received serial number are not identical to the provider company code and the serial number stored in the database, and
the second comparison unit outputs a second signal having the first logic level if the test password is identical to the reference password, and outputs the second signal having the second logic level if the test password is not identical to the reference password.

12. The integrated authentication server of claim 11, wherein the verification unit generates the authentication signal for permitting use of the authentication device if the second signal being output from the second comparison unit has the first logic level, and generates the authentication signal for rejecting use of the authentication device if the second signal being output from the second comparison unit has the second logic level.

13. The integrated authentication server of claim 12, wherein the verification unit outputs the control signal having the first logic level if the second signal being output from the second comparison unit has the first logic level and the first signal being output from the first comparison unit has the first logic level, and outputs the control signal having the second logic level if the second signal being output from the second comparison unit has the first logic level and the first signal being output from the first comparison unit has the second logic level.

14. The integrated authentication server of claim 13, wherein the data generation unit registers the company code as the provider company code if the control signal has the first logic level and registers the provider company code with a registration information sheet corresponding to the serial number of the authentication device, and the data generation unit registers the company code as the member company code if the control signal has the second logic level, and registers the member company code with the registration information sheet corresponding to the serial number of the authentication device.

15. The integrated authentication server of claim 14, further comprising:
a fee control unit storing authentication fee information of a member company corresponding to the member company code and forwarding the authentication fee information to the provider company on the registration information sheet, if the control signal has the second logic level.

16. The integrated authentication server of claim 15, wherein the provider company is a company which initially provides the authentication device to a user, and the member company is a company exclusive of the provider company, which desires password authentication using the authentication device provided by the provider company.

17. The integrated authentication server of claim 16, wherein each of the provider company and the member company comprises an authentication server which performs user authentication by means of an identification (ID) of the user and password authentication using the authentication device.

18. The integrated authentication server of claim 10, further comprising a reference password generation unit generating the reference password if receiving the test password.

19. The integrated authentication server of claim 10, wherein the authentication device is a one time password (OTP) generator.

20. The integrated authentication server of claim 10, wherein the authentication device is a password generator using fingerprint recognition or iris recognition, and the integrated authentication server further comprises a storage unit storing fingerprint information or iris information of the user of the authentication device.

21. An integrated authentication method using an integrated authentication server, the integrated authentication method comprising:
receiving an access request for requesting an access using an authentication device from a user having the authentication device!
requesting authentication for the authentication device by transmitting integrated authentication request information and a company code, and a serial number of the authentication device to the integrated authentication server in response to the access request;
permitting the user's access using the authentication device if authentication for the authentication device is approved; and
transmitting authentication fee information for the authentication device to the integrated authentication server.

22. The integrated authentication method of claim 21, wherein the user is provided with the authentication device from a predetermined provider company, and the integrated authentication method further comprises forwarding the authentication fee information transmitted to the integrated authentication server to the provider company.

23. The integrated authentication method of claim 21, wherein the integrated authentication server registers the serial number of the authentication device and the company code with a registration information sheet and compares a test password generated by the authentication device with a reference password for authentication of the authentication device.

24. The integrated authentication method of claim 21, wherein the permitting of the user's access using the authentication device comprises permitting the user's access by receiving an identification (ID) of the user and a password generated by the authentication device, and the authentication device is a one time password (OTP) generator.
